(19) United States
(12) Patent Application Publication
(10) Pub. No.: US 2026/0327039 A1
(43) Pub. Date: Oct. 22, 2026

(54) Fish Tape Tool and Reel System

(71) Applicant: Klein Tools, Inc., Mansfield, TX (US)

(72) Inventors: Sarah Groeschel, Arlington, TX (US); Tyler Murphey, Midlothian, TX (US); Jonathan Low, Fort Worth, TX (US); Stephen Hughett, Midlothian, TX (US); Soo In Ma, Mansfield, TX (US)

(73) Assignee: Klein Tools, Inc., Mansfield, TX (US)

(21) Appl. No.: 19/634,258

(22) Filed: Mar. 31, 2026

Related U.S. Application Data
(60) Provisional application No. 63/791,768, filed on Apr. 21, 2025.

(51) Int. Cl. B65H 75/40; H02G 1/08

(52) U.S. Cl. CPC B65H 75/406; H02G 1/085; B65H 2402/412; B65H 2701/376

(57) ABSTRACT

A fish tape tool is provided including a fish tape having a length extending from a first end to a second end, and a donut shaped case having a central axis. The donut shaped case includes a pair of sidewalls extending between a radially innermost wall and a radially outermost wall. At least one opening in the donut shaped case extends from a first sidewall to a second sidewall and is positioned between the radially innermost wall and the radially outermost wall. A fish tape system including a fish tape tool having a donut shaped case with a first opening and a second opening configured to receive electrical conduit for rotation of the fish tape is also provided.

### CROSS-REFERENCE TO RELATED APPLICATIONS

This application claims priority to U.S. Provisional Patent Application No. 63/791,768, filed on Apr. 21, 2025 which is incorporated herein by reference in its entirety.

### TECHNICAL FIELD

The present disclosure relates to a fish tape tool and reel system that includes a plurality of through-holes configured to receive a foreign cylindrical object, such as an electrical conduit or screwdriver shaft, to controllably pay out and reel in fish tape.

### BACKGROUND

Fish tape is a deployment and retrieval tool primarily used by tradesmen, namely electricians, to route and guide new wiring through electrical conduits, walls, ceilings, floors, and other miscellaneous enclosed areas. A fish tape tool uses a fish tape that has an elongated member composed of tempered spring steel, stainless steel, nylon, fiberglass with a nylon jacket, polyester, or other similar material. The fish tape material is structured so that it is stern enough to be forced through electrical conduit, but still nimble enough to bend as needed to curve around corners and angles. Typically, fish tape reels may have a length range from as little as 3 feet, up to 1000 feet, wherein the fish tape is conveniently stored within a casing or housing.

Conventional fish tape enables a user to manually pull the fish tape out of the housing to run the fish tape and then reel the fish tape by rolling it back into the housing. Depending on the size, length, and material of the fish tape, manually having to pay out or reel in the fish tape results in an arduous, labor intensive, physically taxing and time-consuming task. Although there are powered fish tapes that can reel in the tape automatically, this typically results in increased costs and/or additional materials, both of which can be incommodious to tradesman trying to complete a project within time and budget constraints. An ergonomically safe and time efficient solution is needed to ensure an alternative to the prior art of fish tapes described above.

### BRIEF SUMMARY

The present disclosure improves upon the issue of providing an ergonomically safe and time efficient tool to pay-out and reel-in fish tape by providing a fish tape tool system that includes apertures configured to receive a foreign object to aid in the deployment and retrieval of fish tape. In particular, the present disclosure addresses disadvantages of physically manipulating and operating a fish tape reel, which is labor intensive and increases ergonomic tension and stress in tradesman, such as electricians.

A fish tape tool may be summarized as including: a fish tape having a length extending from a first end to a second end; a donut shaped case having a central axis that includes a pair of sidewalls extending between a radially innermost wall and a radially outermost wall; and at least one opening in the donut shaped case extending through a first sidewall to a second wall, wherein the at least one opening is arranged between the radially innermost wall and the radially outermost wall.

The fish tape tool may include a second opening in the donut shaped case that extends from the first sidewall to the second sidewall, wherein the second opening is arranged between the radially innermost wall and the radially outermost wall. The fish tape tool may include a handle engaged with the fish tape. The first end of the fish tape may protrude from an aperture in the handle, and the second end of the fish tape may be retained in a fish tape storage compartment defined by the pair of sidewalls. The first opening may have a first dimension, and the second opening may have a second dimension, wherein the second dimension is greater than the first dimension.

The pair of sidewalls may include at least one gripping portion along a portion of the radially innermost wall. The pair of sidewalls may be coupled by a plurality of fasteners. The first opening or the second opening may have a third dimension, wherein the third dimension may be greater than the first and second dimensions. The first and second openings may be configured to receive a foreign object to enable rotation of the fish tape tool about the central axis of the donut shaped case.

A fish tape tool may be summarized as including: a fish tape; a housing surrounding the fish tape, the housing include a first cover, a second cover opposite to the first cover, and a central axis; a first aperture extending through the first cover to the second cover; and a second aperture extending through the first cover to the second cover, wherein the first and second apertures may be configured to receive a foreign object.

The first aperture includes a first width, and the second aperture includes a second width, wherein the second width may be greater than the first width. The housing may include a radially innermost wall and a radially outermost wall, wherein the first and second apertures are positioned between the radially innermost and radially outermost walls. A plurality of fasteners couple the first cover to the second cover. The fish tape tool may include a handle engaged with the fish tape and configured to slide within an annular opening of the housing around an entire periphery of the fish tape tool. The fish tape tool may further include a plurality of gripping portions arranged on a portion of at least one cover of the housing. Each respective gripping portion may be spaced at an equal distance from an adjacent gripping portion radially surrounding the central axis of the housing.

A fish tape system may be summarized as including: a fish tape tool having a donut shaped case with a central axis; a first opening in the case; and a second opening in the case, wherein the first opening and the second opening are configured to receive an object for a rotation for the fish tape tool about the central axis to deploy or retrieve a fish tape. The object may be an electrical conduit. The first or second opening may correspond to fit at least a ½″ width of electrical conduit. The first or second opening corresponds to fit a 1″ width of electrical conduit.

### BRIEF DESCRIPTION OF THE DRAWINGS

FIG. 1 is an isometric view of a fish tape tool according to a preferred embodiment of the present disclosure.

FIG. 2 is a front view of the fish tape tool.

FIG. 3 is a left-side view of the fish tape tool.

FIG. 4 is an isometric exploded view of the fish tape tool.

FIG. 5 is a cross-sectional view of the fish tape tool.

FIG. 6 is dissembled view of a bottom portion of the fish tape tool.

FIG. 7 is an isometric view of a fish tape tool according to an alternative embodiment.

FIG. 8 is an isometric view of a fish tape spacer according to the alternative embodiment in FIG. 7.

FIG. 9 is an exploded view of the fish tape tool in FIG. 7.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

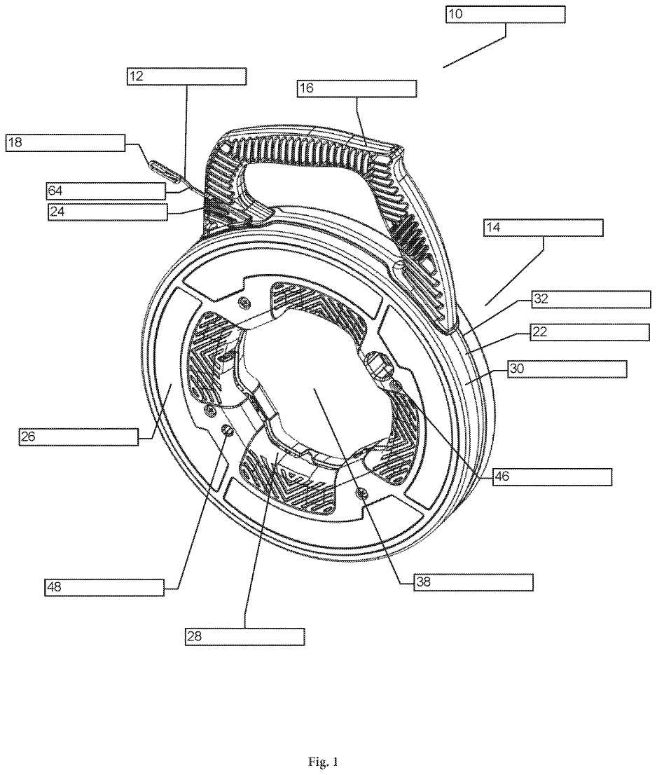

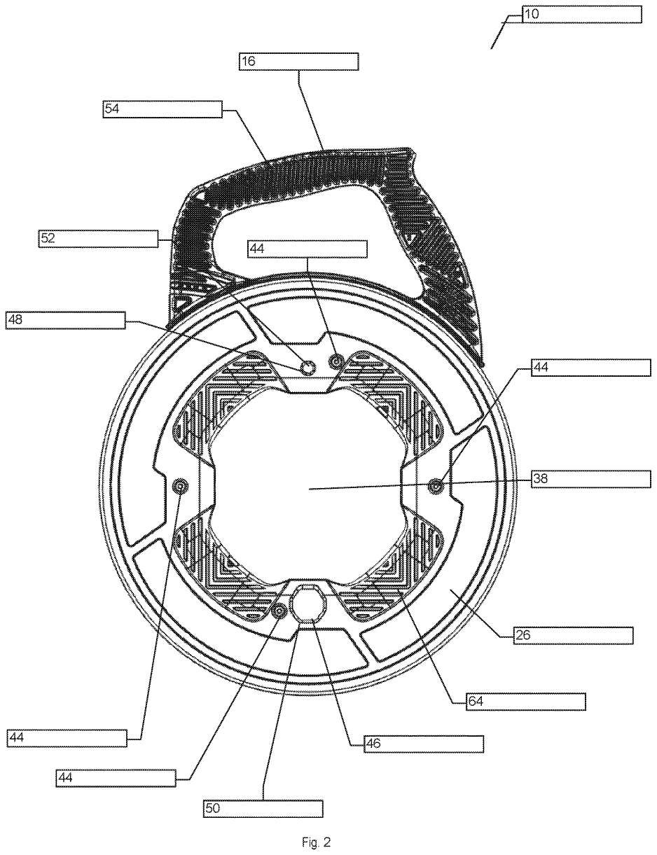

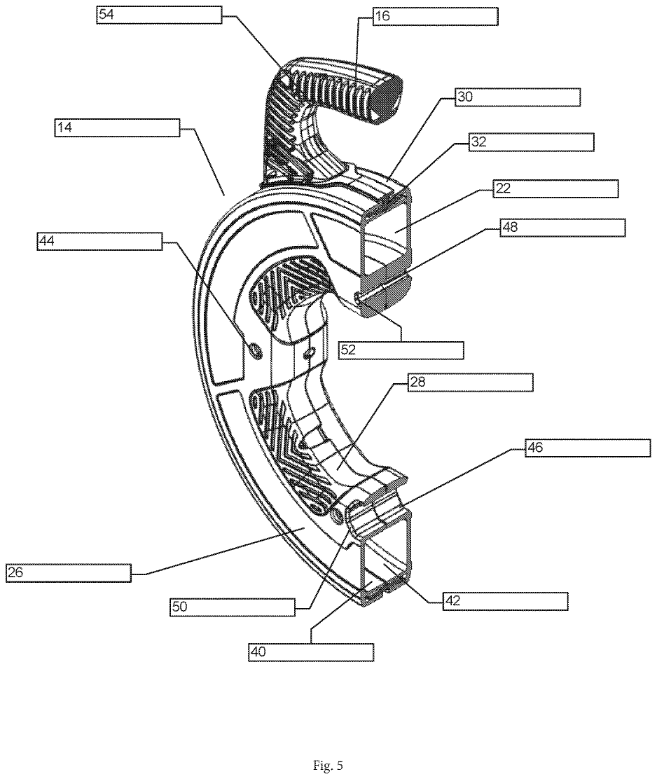

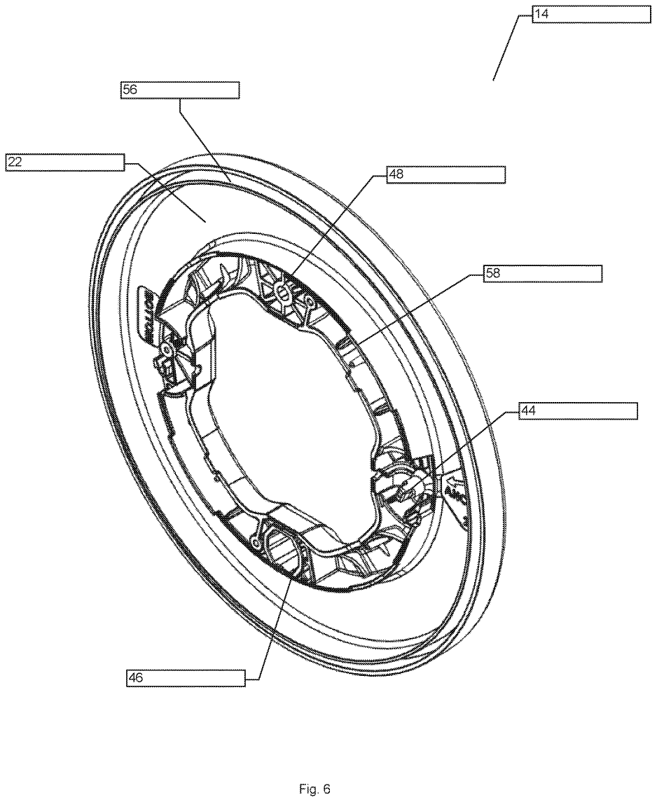

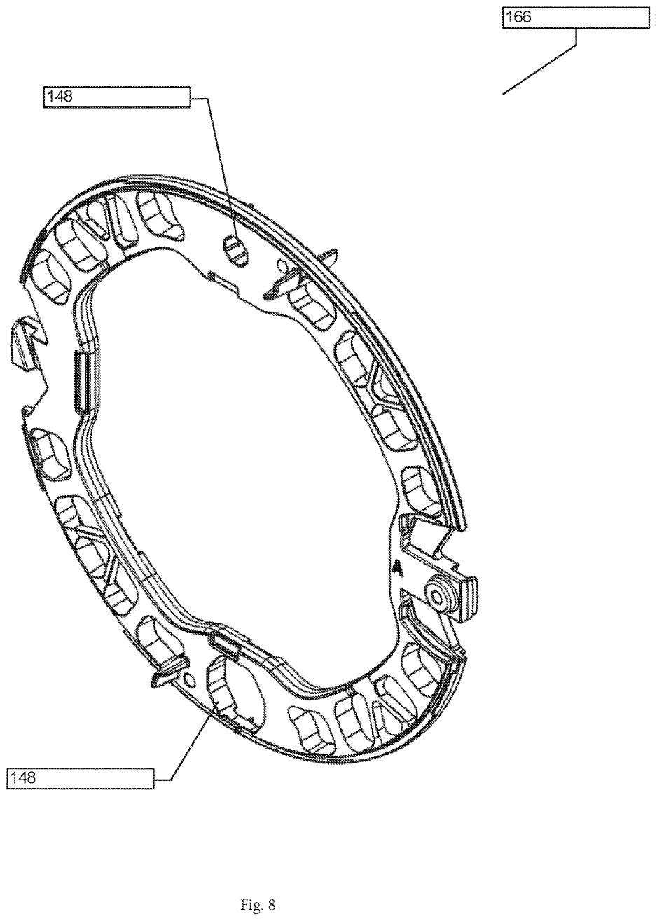

Throughout the present description for the embodiment shown in FIGS. 1-9, the terms “upper”, “lower”, “top”, “bottom”, “left”, “right”, “front”, “forward”, “rear”, and “rearward” shall define directions or orientations with respect to the fish tape tool as illustrated in FIG. 1. It will be understood that the spatially relative terms “upper”, “lower”, “top”, “bottom”, “left”, “right”, “front”, “forward”, “rear”, and “rearward” are intended to encompass different orientations of the fish tape reel in use or operation in addition to the orientation depicted in the figures. For example, if the fish tape reel in the figures is turned over, elements described as “upper” elements or features would then be “lower” elements or features. The terms “fish tape reel,” “fish tape tool and system,” and “fish tape tool” are synonymous and refer to the same feature.

As seen in FIGS. 1-9, a fish tape tool and system 10 is provided and includes a fish tape 12, a case 14, and a handle 16. The fish tape 12 has a length that extends from a first end 18 (e.g., hook end) to a second end 20 (e.g., anchor end). The case 14 includes a fish tape storage compartment 22 that is coupled to the handle 16 and stores the fish tape 12 for deployment via an annular opening 24 in the case 14.

In the illustrated embodiment, the case 14 is donut shaped and includes a pair of sidewalls 26 extending between a radially innermost wall 28 and a radially outermost wall 30. The outermost wall 30 includes an opening 32 in the form of an annular opening 32 extending around the entire circumference of the outermost wall 30. The pair of sidewalls 26 are spaced opposite from each other, and in combination with inwardly facing annular surfaces 34 and 36 of the innermost and outermost walls 28, 30, respectively, define the storage compartment 22 with an annular shape. The innermost wall 28 defines a central axis 38 in which the fish tape tool 10 rotates about through user generated force.

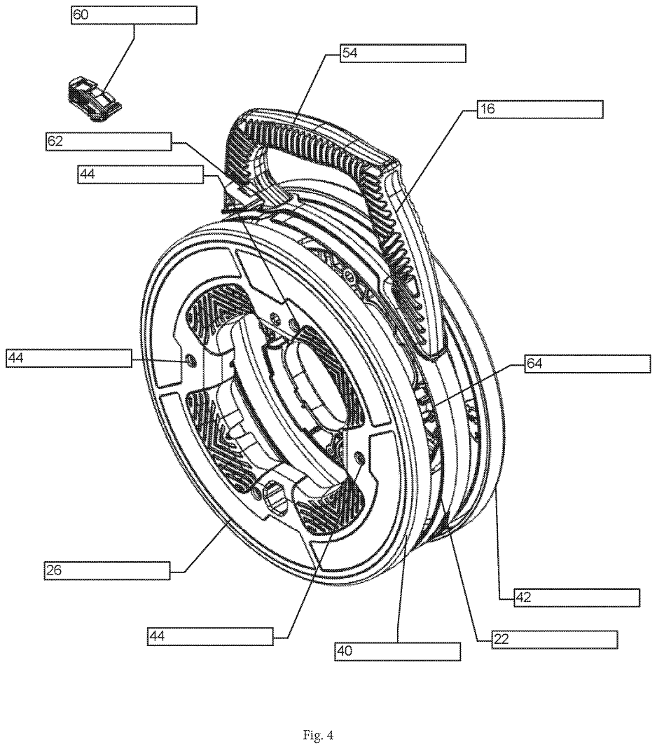

As best seen in FIG. 4, the illustrated embodiment of the fish tape tool 10 is an assembly of two, half-case components 40 and 42 that are coupled to each other by a plurality of fasteners 44. Each of the components 40, 42 define one of the sidewalls 26 and approximately one-half of each of the sidewalls 26 are preferably molded using a suitable process, such as injection molding.

In the illustrated and preferred embodiment, a first through-hole 46 and second through-hole 48 are integrally formed in the case 14 and extend from one sidewall 26, through the components 40, 42, to the other sidewall 26. The first and second through-holes 46, 48 are arranged between the radially innermost wall 28 and the radially outermost wall 30. In the illustrated embodiment, the first through-hole 46 includes a third sidewall 50 having a 1-inch width, and the second through-hole 48 includes a fourth sidewall 52 having a 0.315-inch width. In some embodiments, the third sidewall 50 may have a width that is greater than, less than, or equal to the fourth sidewall 52. In some embodiments, the fourth sidewall 52 may have a width that is greater than, less than, or equal to the third sidewall 50.

The first and second through-holes 46, 48 are configured to allow insertion of a cylindrical object (not shown) for rotation of the case 14 relative to the handle 16 for deployment or retrieval of the fish tape 12. In operation, a user may grasp the handle 16, insert an cylindrical object (i.e., an electrical conduit, shaft from a screwdriver) to provide a torsional or rotational movement, and rotate the case 14 relative to the handle 16 about the central axis 38. The cylindrical object enables the user to easily deploy or retrieve the fish tape 12 in either a clockwise or counterclockwise direction. Alternatively, a user may grasp the handle 16 and gripping portions 64 that are spaced along a portion of the radially innermost wall 26 to rotate the fish tape 12 in a traditional manner.

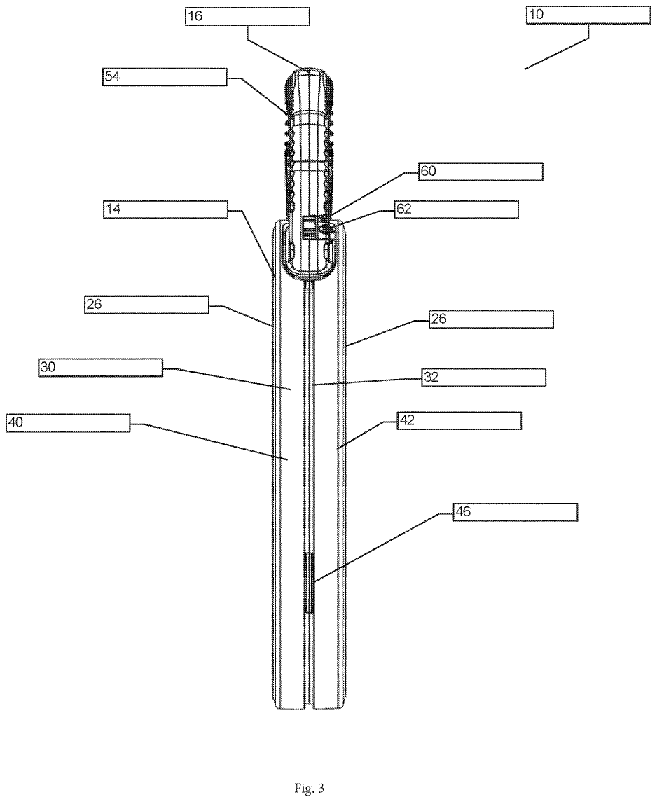

In the illustrated and preferred embodiment of the fish tape tool 10, the handle 16 is mounted to slide within the annular opening 24 around the entire circumference of the outermost wall 30. The handle 16 includes a grip 54, for example, a pistol grip, and a ring 56. As best seen in FIGS. 3 and 4, the ring 56 has oppositely facing annular ribs 58, with each rib received in a corresponding annular channel in a corresponding one of the half-case components 40, 42 for guided, sliding movement around the entire circumference of the outermost wall 30. As best seen in FIGS. 3 and 4, the grip 54 includes a fish tape guide portion 60 having a linear slot 62 that receives and guides the fish tape 12 as it is deployed from and wound into the storage compartment 22.

The fish tape 12 is formed from a structural member 64 that extends the length of the fish tape 12. The structural member 64 may be a flexible strip of metal, a multi-strand metallic wire, or a cord or rope of nylon, fiberglass, or other flexible, high tensile strength material. Each end 18, 20 of the fish tape 12 may be provided in any suitable form and/or configuration, many of which are known, to allow or assist a user in the attachment of an electrical wire or optic cable or in the grasping of the fish tape 12 during a pulling or pushing operation. Non-limiting examples of suitable forms/configurations for the ends 18, 20 include eyelet ends (shown in FIG. 1), hook shaped ends, no-snag plastic tips, bullet ends, mini-eyelet ends, domed-eyelet ends, claw ends, male threaded connector ends, or female threaded connector ends, all of which are commonly known in commercially available fish tape systems and fish rod systems.

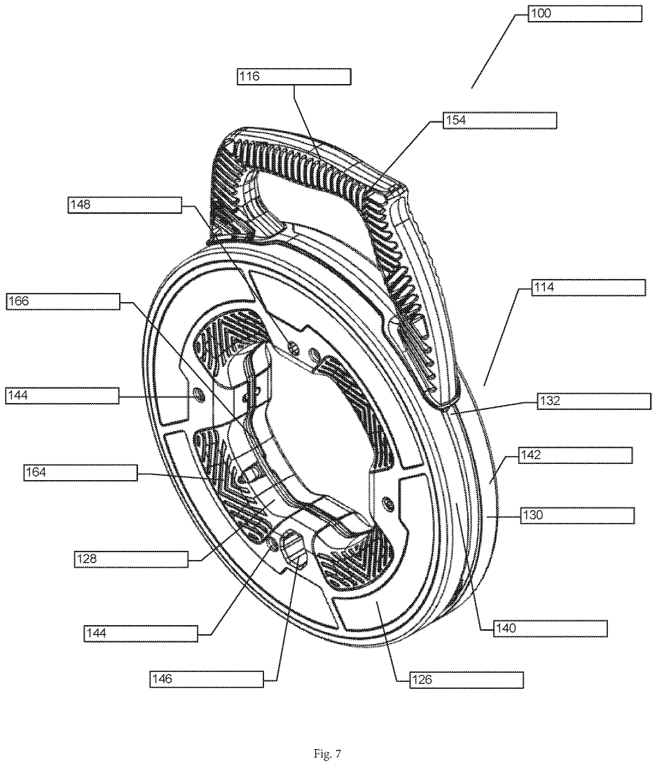

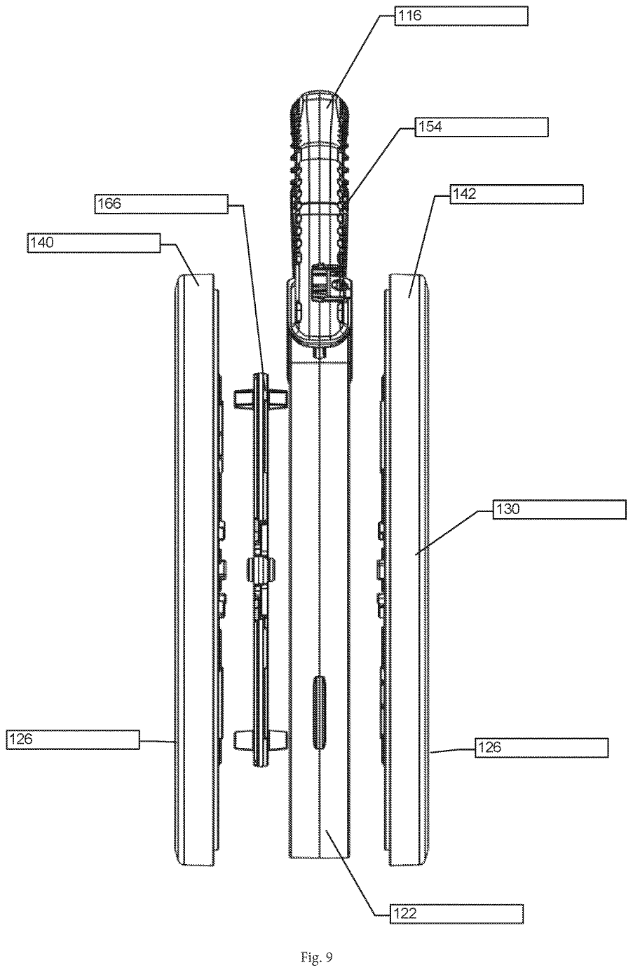

As best seen in FIGS. 7-9, an alternative embodiment of a fish tape tool 100 includes the handle 116, the fish tape 112, the case 114, the first and second through-holes 146, 148, and further includes a middle spacer 166. As best seen in FIGS. 7 and 9, the spacer 166 is interposed between the components 140, 142 to increase a total fish tape width 168. The spacer 166 may increase organization of the fish tape 112 in preventing unnecessary tangling during use or reduce excessive friction between the fish tape 112. The spacer 166 includes through-holes 170 that correspond to the through-holes 146, 148 provided in the case 114, further enabling a user the advantage of insertion of the cylindrical object into the through-opening 146, 148 for secure rotation of the fish tape tool 110.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the fish tape tool 10 are shown in the figures, it should be understood that this disclosure anticipates variations in the specific details of each of the disclosed components and features of the fish tape tool 10 and that no limitation to a specific form, configuration, or detail is intended unless expressly and specifically recited in an appended claim.

For example, while specific and preferred forms have been shown for the case 14, in some applications other forms and configurations for the case 14 may be employed. For example, while the through-holes 46, 48 are shown to have a hexagonal and circular shape, in some applications a different opening configuration/shape may be desired. In another example, while the two-half case components 40, 42 are preferred, in some embodiments it may be desirable to form the case 14 from a different configuration of components or a different number of components. Similarly, while the donut shape is a preferred form from the case 14, in some applications it may be desirable for the case 14 to have a different shape. As yet another example, while the disclosed configuration for the handle 16 is preferred, in some applications it may be desirable to utilize other configurations, many of which are known, for a winding handle. Similarly, in some applications it may be desirable for the fish tape tool 10 to not have any type or configuration of a winding handle.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are herby incorporated by reference to the same extent as if each reference were individually and specifically indicated to be incorporated by reference and were set forth in its entirety herein.

What is claimed is:

1. A fish tape tool, comprising:
a handle;
a fish tape having a length extending from a first end to a second end;
a donut shaped case having a central axis, the donut shaped case including:
a pair of sidewalls extending between a radially innermost wall and a radially outermost wall, the radially innermost wall defining a central opening extending through the donut shaped case; and
at least one through-hole integrally formed in the donut shaped case extending from a first sidewall to an opposite second sidewall, wherein the at least one through-hole is configured to allow insertion of a cylindrical object for rotation of the donut shaped case relative to the handle for extending or retracting the fish tape.

2. The fish tape tool of claim 1, further comprising a second through-hole in the donut shaped case extending from the first sidewall to the opposite second sidewall, the second through-hole arranged between the radially innermost wall and the radially outermost wall and configured to allow insertion of the cylindrical object for rotation of the donut shaped case relative to the handle for extending or retracting the fish tape.

3. The fish tape tool of claim 1, further comprising a handle engaged with the fish tape.

4. The fish tape tool of claim 3, wherein the first end of the fish tape protrudes from an aperture in the handle, and the second end of the fish tape is retained in a fish tape storage compartment defined by the pair of sidewalls.

5. The fish tape tool of claim 1, wherein the first through-hole has a first dimension, and the second opening has a second dimension, wherein the second dimension is greater than the first dimension.

6. The fish tape tool of claim 1, wherein the pair of sidewalls include at least one gripping portion along a portion of the radially innermost wall.

7. The fish tape tool of claim 1, wherein the pair of sidewalls are coupled by a plurality of fasteners.

8. The fish tape tool of claim 1, wherein the first through-hole or the second through-hole is a third dimension, wherein the third dimension is greater than the first and second dimensions.

9. The fish tape tool of claim 1, wherein the cylindrical object is an electrical conduit or a screwdriver shaft.

10. A fish tape tool, comprising:
a fish tape;
a housing surrounding the fish tape, the housing including a first cover, a second cover opposite the first cover, and a central axis;
a first aperture extending through the first cover to the second cover; and
a second aperture extending through the first cover to the second cover, wherein the first and second apertures are configured to receive a circular object.

11. The fish tape tool of claim 10, wherein the first aperture includes a first width, and the second aperture includes a second width, the second width being greater than the first width.

12. The fish tape tool of claim 10, wherein the housing includes a radially innermost wall and a radially outermost wall, the first and second apertures positioned between the radially innermost and radially outermost walls.

13. The fish tape tool of claim 10, wherein a plurality of fasteners couple the first cover to the second cover.

14. The fish tape tool of claim 10, further comprising a handle engaged with the fish tape and configured to slide within an annular opening of the housing around an entire periphery of the fish tape tool.

15. The fish tape tool of claim 10, further comprising a plurality of gripping portions arranged on a portion of at least one cover of the housing.

16. The fish tape tool of claim 15, wherein each respective gripping portion is spaced at an equal distance from an adjacent gripping portion radially surrounding the central axis of the housing.

17. A fish tape system, comprising:
a handle;
a fish tape tool having a donut shaped case with a central axis, the donut shaped case coupled to the handle;
a first through-opening in the case; and
a second through opening in the case, wherein the first and second through-openings are configured to receive an object having a cylindrical outer shape for a rotation of the fish tape tool about the central axis to deploy or retrieve a fish tape.

18. The fish tape system of claim 17, wherein the object is an electrical conduit or screwdriver.

19. The fish tape system of claim 17, further comprising a spacer interposed in the donut shaped case.

20. The fish tape system of claim 17, wherein the first or second through-opening corresponds to fit a 1-inch width electrical conduit.
